(19) United States
(12) Patent Application Publication
(10) Pub. No.: US 2005/0253387 A1
(43) Pub. Date: Nov. 17, 2005

(54) Connecting device

(76) Inventors: Andreas Fritz, Oetisheim (DE); Martin Bayha, Korntal-Muenchingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/128,186

(22) Filed: May 13, 2005

(30) Foreign Application Priority Data
May 14, 2004 (DE) 10 2004 023 995.9

(51) Int. Cl. F16L 27/04

(52) U.S. Cl. 285/365

(57) ABSTRACT

A connecting device includes a ring element which has a V-shaped cross-section and is connected with a face-side flange of the exhaust gas inlet pipe. The V-shaped ring element is supported with one of its sloping surfaces on an opposite sloping surface of a ring element having an angular cross-section. The ring element with an angular cross-section is arranged and connected with the receiving pipe in the area of the insulation for the catalyst, and both the V-shaped ring element and the angular ring element are fastened in a cohesive manner jointly by way of a tensioning clamp.

This application claims the priority of German application 10 2004 023 995.9, filed May 14, 2004, the disclosure of which is expressly incorporated by reference herein.

### BACKGROUND AND SUMMARY OF THE INVENTION

This invention relates to a connecting device for pipes of an exhaust system, one pipe being constructed as an exhaust gas inlet pipe and an additional adjoining pipe being constructed as a receiving pipe for a catalyst provided with insulation, with the exhaust gas inlet pipe being detachably connected with the receiving pipe by way of a clamping connection.

A connecting device for exhaust pipes having connecting elements molded on at an end side and a V-shaped cross-section is known from German Patent Document DE 199 59 955 C2. A connecting device for exhaust pipes in which one exhaust pipe has an outwardly oriented connecting flange and an additional connecting exhaust pipe is equipped with a connecting element having an approximately V-shaped cross-section is furthermore known from International Patent Document WO 02/066801 A1.

It is an object of the invention to provide an improved connecting device for exhaust pipes so that an exchange of a catalyst from one of the exhaust pipes is simplified and, furthermore, a decrease of the gas temperature in front of the catalyst is avoided.

According to the invention, this object is achieved by having the connecting device include a first ring element with a V-shaped cross-section connected with a face-side flange of the exhaust gas inlet pipe and having sloping surfaces, and a second ring element including an opposite sloping surface on which one of the sloping surfaces of the first ring element is supported. Additionally according to the invention, the second ring element has an angular cross-section and is connected with the receiving pipe, and a V-shaped tensioning clamp of a connecting device reaches in a cohesive manner jointly over the V-shaped ring element and the angular ring element. Further advantageous features are defined by dependent claims.

Principal advantages achieved by the invention are ensuring both fast and easy exchangeability of a catalyst from the receiving pipe by way of the connecting device and unrestricted gas flow guidance in front of the catalyst. Again, this is essentially achieved by way of a ring element with a V-shaped cross-section which is connected with a front-side flange of the exhaust gas inlet pipe, with the ring element being supported with of one of its sloping surfaces on an opposite sloping surface of a ring element with an angular cross-section. This ring element is connected with the receiving pipe, and a V-shaped tensioning clamp of a connecting device cohesively reaches jointly over the V-shaped ring element and the angular ring element.

As a result of the connecting device construction and arrangement, the course of the flow in the exhaust gas inlet pipe is unhindered by the device, and the connecting device can be closed in a simple manner and opened for removing the catalyst.

According to the invention, furthermore, the face-side flange of the exhaust gas inlet pipe extends radially toward the outside and is arranged in a plane with an opposite connecting flange of the V-shaped ring element which reaches from the outside over the receiving pipe. As a result of this connecting element construction at the exhaust gas inlet pipe, minimal space is required, and the discharge surface of the exhaust gas outlet pipe corresponds almost to the diameter or to the inflow cross-section of the catalyst.

It is additionally provided according to the invention that the angular ring element with its leg is arranged in the area of the insulation of the catalyst and is connected with the receiving pipe in this area. The additional adjoining leg reaches from the outside over the sloping surface of the V-shaped ring element and is arranged to correspond with the latter. As a result of connecting the angular ring element with its one leg on the receiving pipe in the area of the insulation of the catalyst, no disadvantageous decrease of the gas temperature is generated in front of the catalyst, so that the exhaust gas temperature is not reduced by thermal masses.

According to another embodiment of the invention, the exhaust gas inlet pipe and the receiving pipe are each connected with a ring element having an angular cross-section. The ring elements both have fastening flanges, radially projecting in or parallel to a plane, which can be connected in an opposite and mutual manner. Also, in this embodiment, the angular ring element connected with the receiving pipe is situated with one leg in the area of the insulation of the catalyst and is connected with the receiving pipe. As a result, a simple exhaust pipe connecting device is created which can be detached and closed rapidly and which also comprises all advantages, such as in particular concerning guidance of the flow and the gas temperature in front of the catalyst, mentioned above.

According to another embodiment, the angular ring element is molded to the end side of the gas inlet pipe, and the V-shaped additional ring element is fastened with a leg on the receiving pipe in the area of the insulation.

Embodiments of the invention are illustrated in the drawings and will be described in detail.

### BRIEF DESCRIPTION OF THE DRAWINGS

FIG. 1 is a sectional view of a connecting device between a gas inlet pipe and a receiving pipe for a catalyst;

FIG. 2 is a diagrammatic view of a part of the exhaust system with the connecting device;

FIG. 3 is a view of another embodiment of a connecting device between the exhaust gas inlet pipe and the receiving pipe for a catalyst; and

FIG. 4 is a view of another embodiment of a connecting device between the exhaust gas inlet pipe and the receiving pipe for a catalyst.

### DETAILED DESCRIPTION OF THE INVENTION

An exhaust system 1 includes, among other elements, an exhaust gas inlet pipe 2 which is connected with a receiving pipe 3 for a catalyst 4 by way of a connecting device 5; 5a; 5b. The catalyst 4 is surrounded by insulation 6 and is arranged in the receiving pipe 3. An exhaust gas flow 8 coming from the engine flows in the direction of the arrow through the exhaust gas inlet pipe 2, and subsequently through the catalyst 4 and the insulation 6, having the purpose of preventing a heat flow-off.

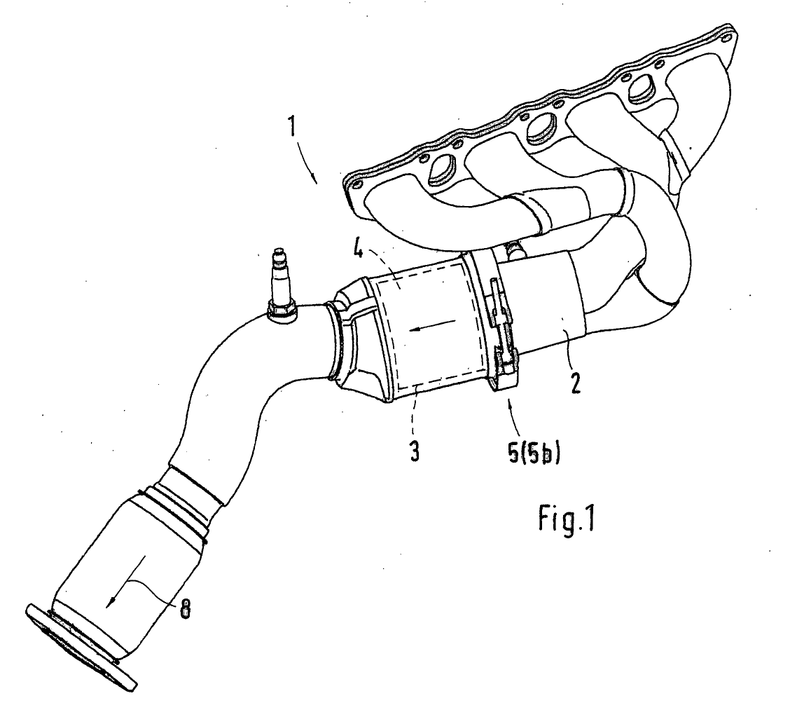

The connecting device 5; 5a; 5b is provided to permit a fast and uncomplicated exchange of the catalyst 4 from the receiving pipe 3 to take place. In a first embodiment according to FIGS. 1 and 2 or 4, the connecting device has a face-side flange 9 on a face of the exhaust gas inlet pipe 2, which flange extends in a plane X-X radially toward the outside. A ring element 10 with a V-shaped cross-section is connected with this flange 9; the ring element 10, for this purpose, has a fastening surface 11 which is situated opposite the face-side flange 9. The flange 9 and this fastening surface 11 are mutually connected by way of welding or soldering 12.

The V-shaped ring element 10 comprises two sloping surfaces 14, 15 which are oriented in a “roof” shape. One sloping surface 15 of the ring element 10 faces another angular ring element 16 which is fixedly connected by way of welding or soldering 17 with the receiving pipe 3 for the catalyst 4.

According to the invention, it would be conceivable for the angular ring element 16a to also be molded to the end side of the gas inlet pipe 2 and for the V-shaped ring element 10a to be fastened by a flange 10b to the receiving pipe 3 for the catalyst 4, as illustrated in detail in FIG. 4.

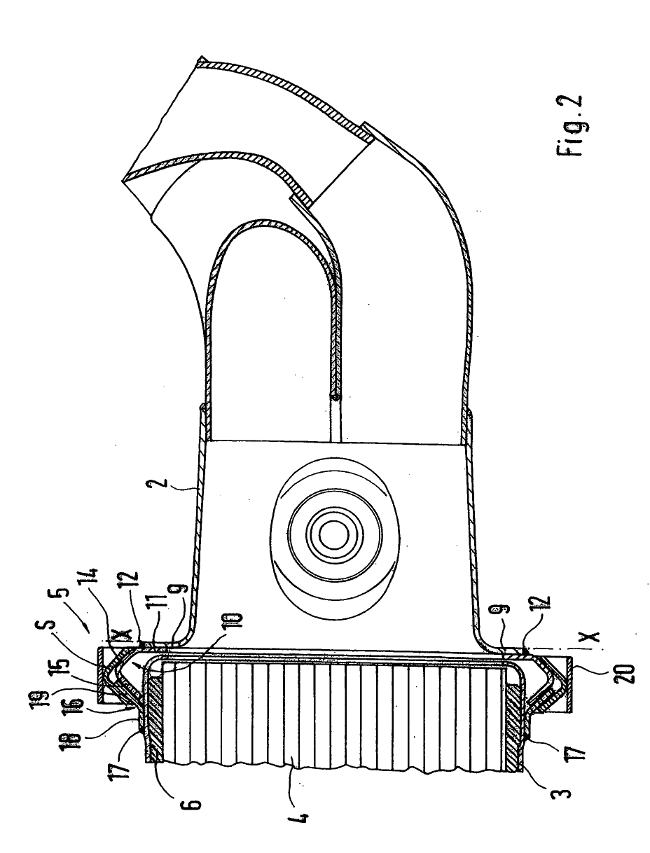

The ring element 16 according to FIG. 2 has an angular cross-section and legs 18, 19 which form the sloping surfaces. One sloping surface of the leg 18 is arranged to correspond with the receiving pipe 3 and the additional sloping surface set at an obtuse angle is arranged to correspond with the sloping surface 15 of the ring element 10 for the connection. A clamping connection of the two ring elements 10 and 16 or 10a and 16a of the pipes 2 and 3 takes place by way of a reaching-around V-shaped tensioning clamp S within a ring element 20 of a connecting device 5; 5b which reaches over the ring elements 10, 16 and 10a, 16 respectively and clamps them together.

The face-side flange 9 of the exhaust gas inlet pipe 2 is provided with a mouth cross-section to the catalyst 4, which corresponds approximately to the diameter of the catalyst 4. The insulation 6 in the receiving pipe 3 for the catalyst 4 extends to almost the face of the catalyst 4, and the angular ring element 16 is arranged in the area of the insulation and is connected with the receiving pipe 3.

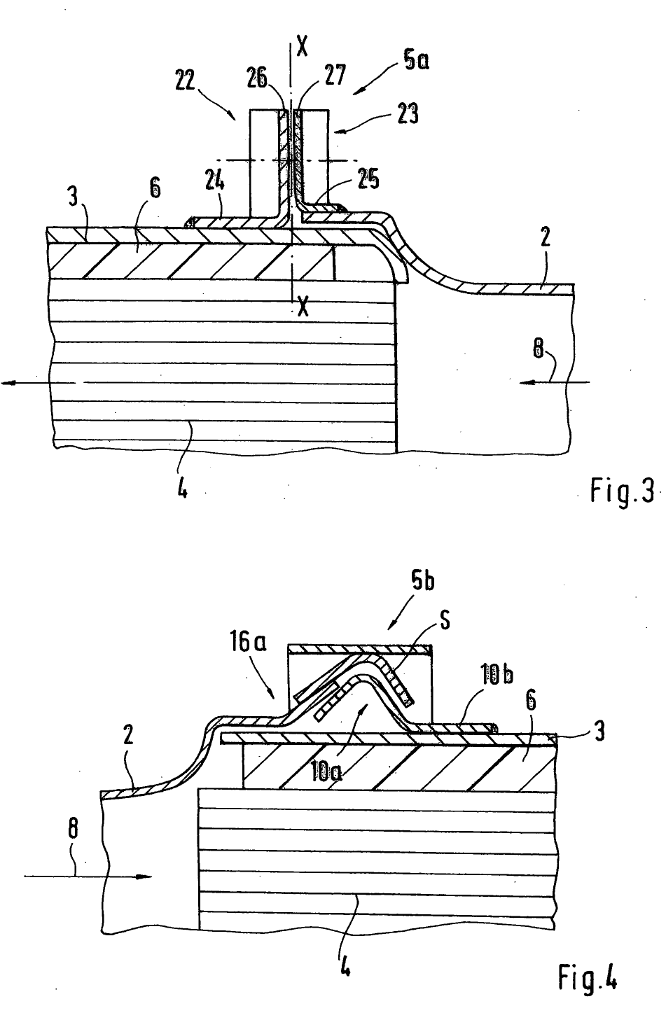

FIG. 3 shows an embodiment in which the exhaust gas inlet pipe 2 is detachably connected with the receiving pipe 3 by way of a clamping connection formed by ring elements 22 and 23. The exhaust gas inlet pipe 2 and the receiving pipe 3 are respectively connected with ring elements 23, 22, each of which has an angular cross-section. Each of the ring elements has a fastening flange 26, 27, formed by one of its legs, radially projecting in or parallel to a plane X-X, and the fastening flanges can be connected in an opposing manner and mutually so as to provide a connecting device 5a. The angular ring element 22, as illustrated, is connected with the receiving pipe 3, with another of its legs 24, in the area of the insulation 6 of the catalyst 4. The angular ring element 23, as illustrated, is connected with the exhaust gas inlet pipe 2 with another of its legs 25 as well.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A connecting device for pipes of an exhaust system, one pipe being constructed as an exhaust gas inlet pipe and an additional adjoining pipe being constructed as a receiving pipe for a catalyst provided with insulation, the exhaust gas inlet pipe being detachably connected with the receiving pipe by way of a clamping connection, the connecting device comprising:
a first ring element having a V-shaped cross-section connected with a face-side flange of the exhaust gas inlet pipe, the first ring element having sloping surfaces,
a second ring element, the second ring element including an opposite sloping surface on which one of the sloping surfaces of the first ring element is supported,
wherein the second ring element has an angular cross-section and is connected with the receiving pipe, and
wherein a V-shaped tensioning clamp of a connecting device reaches in a cohesive manner jointly over the V-shaped ring element and the angular ring element.

2. The connecting device according to claim 1, wherein the face-side flange of the exhaust gas inlet pipe extends radially outward and is arranged in or parallel to a plane, and wherein the first ring element, which reaches from outside over the receiving pipe, has an opposite connecting flange arranged in or parallel to the plane.

3. The connecting device according to claim 1, wherein the second ring element is arranged with a leg in an area of the insulation of the catalyst and is connected with the receiving pipe, wherein the second ring element with the opposite sloping surface reaches from outside over the one of the sloping surfaces of the first ring element and is arranged to correspond with the one of the sloping surfaces.

4. The connecting device according to claim 1, wherein the tensioning clamp reaches from outside with a clamping effect over the first ring element and the second ring element.

5. The connecting device according to claim 2, wherein the second ring element is arranged with a leg in an area of the insulation of the catalyst and is connected with the receiving pipe, wherein the second ring element with the opposite sloping surface reaches from outside over the one of the sloping surfaces of the first ring element and is arranged to correspond with the one of the sloping surfaces.

6. The connecting device according to claim 2, wherein the tensioning clamp reaches from outside with a clamping effect over the first ring element and the second ring element.

7. The connecting device according to claim 3, wherein the tensioning clamp reaches from outside with a clamping effect over the first ring element and the second ring element.

8. The connecting device according to claim 5, wherein the tensioning clamp reaches from outside with a clamping effect over the first ring element and the second ring element.

9. A connecting device for pipes of an exhaust system, one pipe being constructed as an exhaust gas inlet pipe and an additional adjoining pipe being constructed as a receiving pipe for a catalyst surrounded an insulation, the exhaust gas inlet pipe being detachably connected with the receiving pipe by way of a clamping connection, the connecting device comprising:
an angular ring element molded to an end side of the exhaust gas inlet pipe, and
an additional V-shaped ring element with a leg fastened to the receiving pipe in an area of insulation for the catalyst,
wherein the ring elements can be mutually connected.

10. A connecting device for pipes of an exhaust system, one pipe being constructed as an exhaust gas inlet pipe and an additional adjoining pipe being constructed as a receiving pipe for a catalyst surrounded by insulation, the exhaust gas inlet pipe being detachably connected with the receiving pipe by way of a clamping connection, the connecting device comprising ring elements with which the exhaust gas inlet pipe and the receiving pipe are connected, each ring element having an angular cross-section and a fastening flange radially projecting in or parallel to a plane, wherein each fastening flange can be connected to the other in an opposite manner and mutually.

11. The connecting device according to claim 10, wherein one of the ring elements is connected with the receiving pipe with one of its legs and is situated in an area of the insulation.
